(19) United States
(12) Patent Application Publication
(10) Pub. No.: US 2006/0225535 A1
(43) Pub. Date: Oct. 12, 2006

(54) Magnetic nanoparticles

(75) Inventor: David Mainwaring, Victoria (AU)

Correspondence Address: CONNOLLY BOVE LODGE & HUTZ LLP, SUITE 800, 1990 M STREET NW, WASHINGTON, DC, 20036-3425, US

(73) Assignee: Microtechnology Centre Management Limited, Hawthorn (AU)

(21) Appl. No.: 10/558,561

(22) PCT Filed: Jun. 3, 2004
(86) PCT No.: PCT/AU04/00728

§ 371 Date: Nov. 29, 2005

(30) Foreign Application Priority Data
Jun. 4, 2003 (AU) 2003902785

(51) Int. Cl. H01F 1/06

(52) U.S. Cl. 75/348; 75/255; 148/300

(57) ABSTRACT

Nanoparticle sized metal or alloy is synthesized through a reverse micelle system which includes the steps of a) forming a concentrated aqueous solution of transition metal salts with platinum salts b) dispersing the metal salt solution in a non aqueous solution of a surfactant c) adding a reducing agent to reduce the metal salts to metallic alloy nano-particles in the absence of oxygen d) separating the metallic alloy nanoparticles 1s) heating the metallic alloy nanoparticles under controlled time, atmosphere and temperature conditions sufficient to form particles of a desired size and magnetic characteristics. The, precipitated metal or alloy nanoparticle has an average size of 3 nm and is superparamagnetic. Through controlled annealing treatment, the magnetic characteristics of the nanoparticles can be manipulated to achieve specific values in the final product that is suitable for predetermined applications. The nanoparticles exhibiting superparamagnetism are suitable for magnetic bio-bead applications. Weakly ferromagnetic magnetic alloy nanoparticles are suitable for actuator applications. The strongly ferromagnetic magnetic alloy nanoparticles exhibiting high coercivity can be potential candidate for magnetic data storage applications.

This invention relates to a method of synthesizing magnetic alloy nanoparticles from non aqueous solutions.

### BACKGROUND TO THE INVENTION

Cobalt platinum (CoPt) alloys are known for their unique magnetic properties arising from high magnetocrystalline anisotropy. CoPt alloys close to equiatomic composition have been extensively studied in the past as possible candidates for permenant magnets.

According to the phase diagrams reported in the literature, bulk CoPt alloy, similar to CuAu, exists as ordered face centered tetragonal (fct) up to temperatures of 825° C., above which it become disordered face centered cubic (fcc). While the former is a strongly ferromagnetic, the later is a weak ferromagnet. CoPt has first degree atomic ordering and has an fcc structure in a disordered state and L1₀ structure in its ordered state. The L1₀ structure has four atoms per unit cell, the coordinates of the atoms are 2Co at (000, 1/2, 1/2, 0) and 2Pt at (½, 0 ½, 0 ½½). The tetragonal form has a large uniaxial anisotropy K=7×10⁸ erg/cm³. This phase possesses excellent magnetic properties with remanence magnetization Mᵣ of 510 kAm⁻¹, Coercivity H_{c} of 400 kAm⁻¹ and magnetic energy of Uₘₐₓ=76 kJm⁻³. This equiatomic CoPt system is also known to exhibit magneto optic kerr effect. CoPt alloy prepared in the form of thin films are ideally suited for magnetic data storage.

Continuous efforts have been made in the magnetic data recording industry to increase the areal storage density with low noise level. Data storage capabilities of 40-100 Gbit/square inch, with CoPt magnetic particle sizes of 12 nm has been so far reported. The high magnetocrystalline anisotropy observed in the fct phase of equiatomic CoPt alloy is responsible for the high H_{c} values obtained in these materials and it also compensates for the destabilization of the magnetization of the recorded bits due to thermal fluctuations and demagnetizing fields. To achieve this, magnetic thin films with very fine (10 nm) and well-isolated particles with high coercivity is essential.

U.S. Pat. No. 4,902,583 discloses a method of depositing a cobalt platinum magnetic film by sputtering.

One of the limitations of this process is that the deposited CoPt alloy film always have disordered fcc phase and require heat treatment above 600° C. for more than 24 hours for conversion to the required fct phase. Heat treatment for that duration can increase the particle size to more than 10 nm and reduce the inter-particle separation resulting in poor magnetic properties and lower signal to noise ratio in the recorded information.

Many attempts have been made to form nano sized magnetic particles.

European patent 412222 discloses a data storage medium formed by the epitaxial growth of a magnetic thin film.

U.S. Pat. No. 4,983,230 discloses a melt processing method of increasing the coercivity of cobalt platinum alloys.

U.S. Pat. No. 5,456,986 discloses a method of forming a magnetic nanoparticle with a carbon coating by electric arc discharge of packed graphite rods.

U.S. Pat. No. 5,766,306 discloses a method of sonicating a metal carbonyl to produce magnetic nano particles

U.S. Pat. No. 5,108,636 discloses a method of using a crosslinked organosiloxane matrix to form a magnetisable composite.

WO 01/39217 and European patent application 1217616 disclose a method of forming magnetic nanoparticles in a protein matrix. Example 5 of WO 01/39217 prepares a CoPt alloy in a ferritin shell. This has an advantage of forming nanoparticles of a uniform size.

U.S. Pat. No. 5,147,841 discloses a method of using an inverse micelle solution to reduce a metal salt to colloidal particles of the elemental metal or alloy.

U.S. Pat. No. 6,262,129 discloses a method of making nano particles including CoPt magnetic nano particles in a surfactant solution under an inert atmosphere. The nano particles are protected with a phosphine and an organic molecule stabilizer. It is an object of this invention to provide a non melt processing technique for forming magnetic nano particles that is relatively quick and inexpensive.

### BRIEF DESCRIPTION OF THE INVENTION

To this end the present invention provides a method of forming magnetic nanoparticles which includes the steps of
a) forming a concentrated aqueous solution of transition metal salts preferably selected from salts of cobalt, nickel, iron and chromium with platinum salts
b) dispersing the metal salt solution in a non aqueous solution of a surfactant
c) adding a reducing agent to reduce the metal salts to metallic alloy nano-particles in the absence of oxygen
d) Separating the metallic alloy nanoparticles
e) heating the metallic alloy nanoparticles under controlled time, atmosphere and temperature conditions sufficient to form particles of a desired size and magnetic characteristics.

In this invention nanoparticle sized metal or alloy is synthesized through a reverse micelle system. Reverse micellar systems are made of aqueous droplets suspended in non-aqueous medium stabilized by surfactants. The precipitated metal or alloy nanoparticle has an average size of 3 nm and is superparamagnetic. The ratio of the transition metal to platinum in the alloy is x: 1-x where x is from 0.4 to 0.6. Equiatomic alloys are preferred. In the reaction the platinum salt PtCl₄ is used at a concentration of 0.002M to 0.005M and the transition metal salts such as COCl₂.6H₂O, FeCl₂.6H₂O, NiCl₂.6H₂O at 0.002M to 0.0045M.

This invention is partly predicated on the discovery that Cobalt platinum alloys formed in this way can be converted to a face centered tetragonal (FCT) partially ordered structure (L1₀ structure) through annealing treatment at 600° C. for 30 minutes to 12 hours depending on the desired magnetic and particle characteristics required.

As synthesised the nanoparticle formed by the process of this invention is an alloy with face centered cubic (FCC) structure exhibiting weak ferromagnetism. With post synthesis annealing treatment, FCC structure changes to partially ordered face centered tetragonal (FCT) structure with enhanced magnetic coercivity. The invention of this low temperature route using solution chemistry is ideally suited for synthesis of variety of magnetic alloy nanoparticles in transition metal-platinum systems. The metal alloy is synthesized by reduction of metal salts in a non-aqueous medium. The metallic alloy nanaoparticles are preferably separated from the reaction mixture using washing and centrifuge processes. The particle size can be precisely controlled through controlled nucleation and crystal growth. The resulting product is highly homogeneous, with narrow particle size distribution. The low temperature synthesis route of this invention yields alloy nanoparticles with a disordered face centred cubic lattice possible due to the high concentration of point defects in the as synthesized nanoparticles. High temperature annealing treatment enables reduction of these defects resulting in the stabilization of the partially or5dered face centred tetragonal phase(fct or L1₀ phase) which is the room temperature stable phase resulting from the alloy melt that has been reported in the literature. This is also the phase responsible for high magnetic coercivity. A minimum annealing temperature of 600° C. is required for stabilizing the fct phase. In another aspect, this invention provides a method of lowering this fct phase formation temperature by using additives such as Ag, Sb, Bi and Pb. The temperature for fct phase formation can be lowered by 100° C. The additive concentration may be from 5 to 15 at % calculated with respect to Cobalt in an equimetric CoPt alloy.

The magnetic alloy nanoparticles of this invention have potential use in advanced applications such as magnetic bio-beads, thin film microactuators, nanocomposite membranes for the microfluidic pumps and ultrahigh density magnetic data storage media. For instance, the nanoparticles exhibiting superparamagnetism are suitable for magnetic bio-bead applications. Weakly ferromagnetic magnetic alloy nanoparticles are suitable for actuator applications. The strongly ferromagnetic magnetic alloy nanoparticles exhibiting high coercivity can be potential candidate for magnetic data storage applications. Data storage capabilities of >100 Gbit/square inch, with CoPt magnetic alloy particles sizes of 10 nm are possible with this invention.

The magnetic properties as well as the particle size can be precisely controlled through control of post synthesis annealing parameters so that the resulting product is suitable for specific applications.

### DETAILED DESCRIPTION OF THE INVENTION

A preferred embodiment of the invention will be described with reference to the drawings in which:

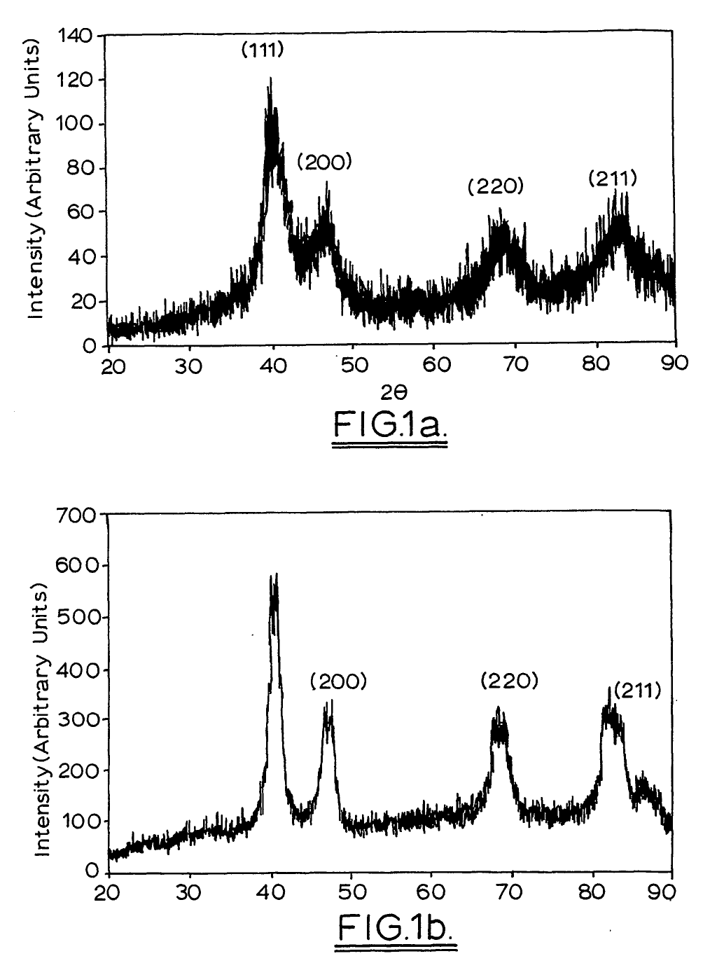

FIG. 1 is an X-ray diffractograms of CoPt particles formed by the method of this invention: 1a) 60° C. dried sample; 1b) 550° C. annealed sample and 1c) 600° C. annealed sample;

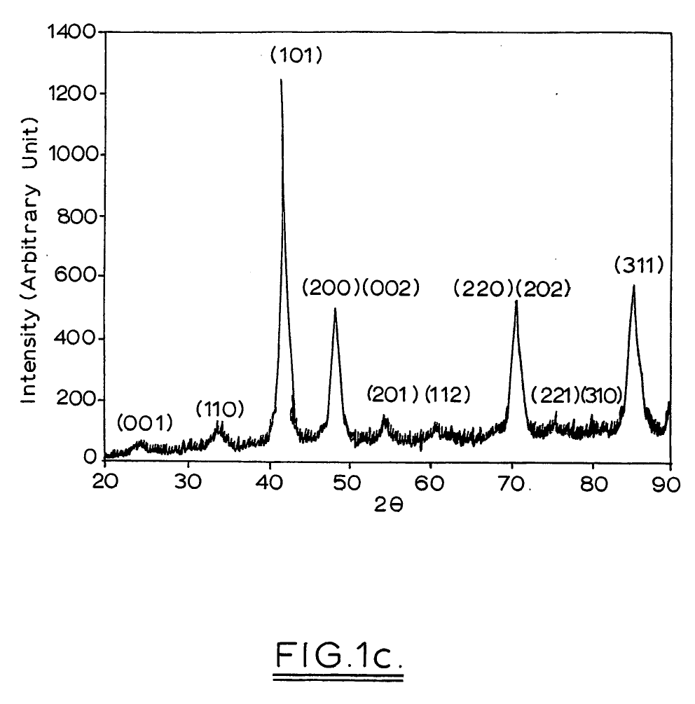

FIG. 2 shows the HRTEM of the CoPt magnetic alloy nanoparticle a) as prepared and b) 600° C. annealed;

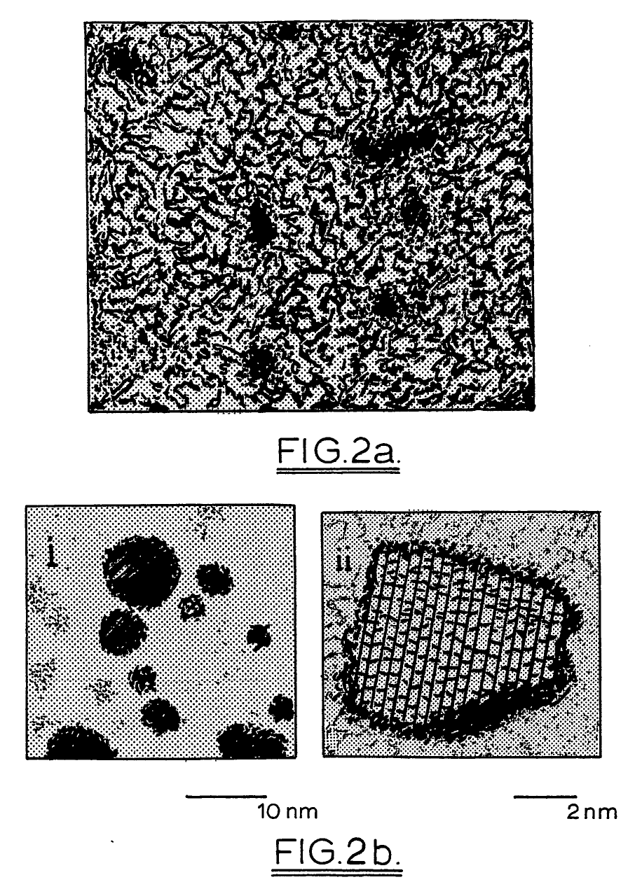

FIG. 3 shows the magnetic hysterisis characteristics for the CoPt samples a) annealed at 350° C.; b) annealed at 550° C. and c) annealed at 600° C.;

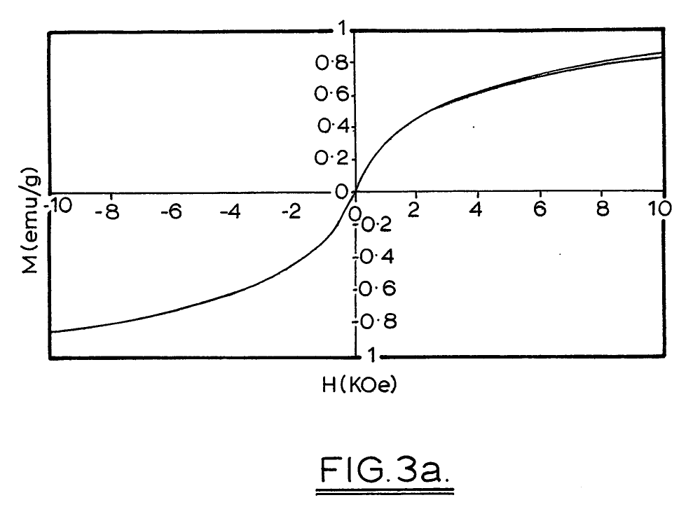

FIG. 4 shows the variation of H_{c} for the CoPt alloy nanoparticle samples and the corresponding c₀/a₀ ratio calculated from their crystal lattice parameters;

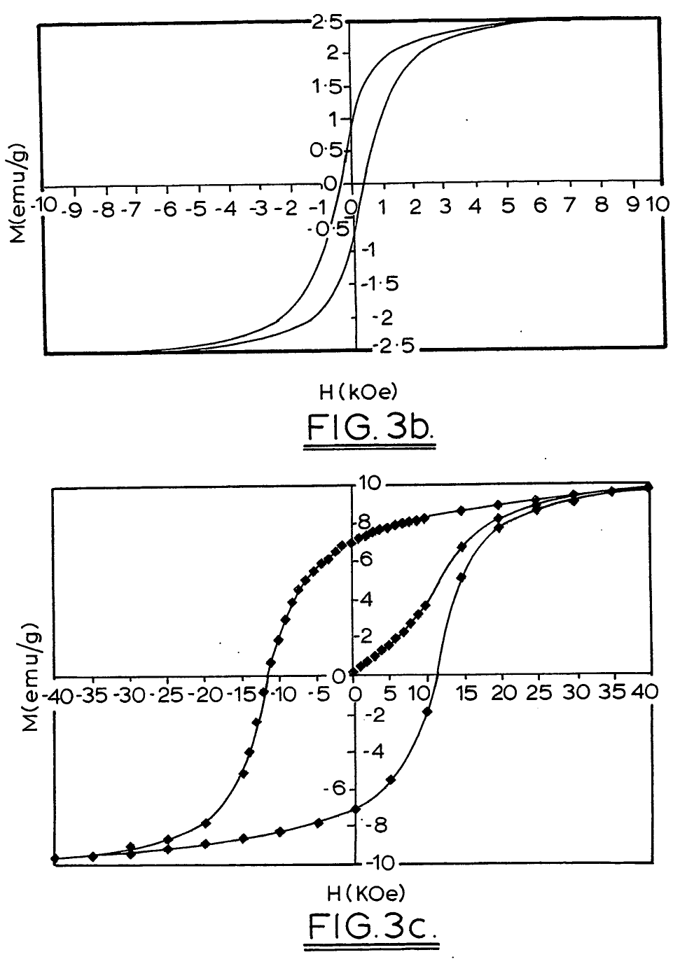

FIG. 5 illustrates XRD patterns of an antimony modified nanoparticle alloy;

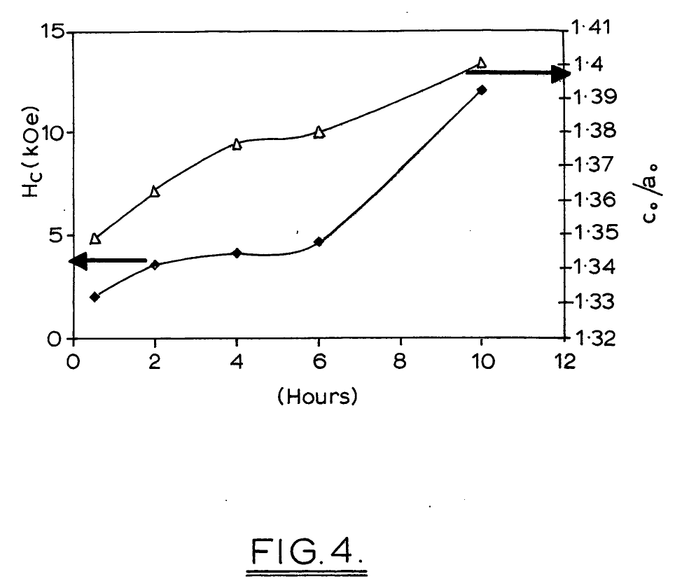

FIG. 6 shows the B-H loop characteristics of an antimony modified nanoparticle alloy annealed at 600° C.;

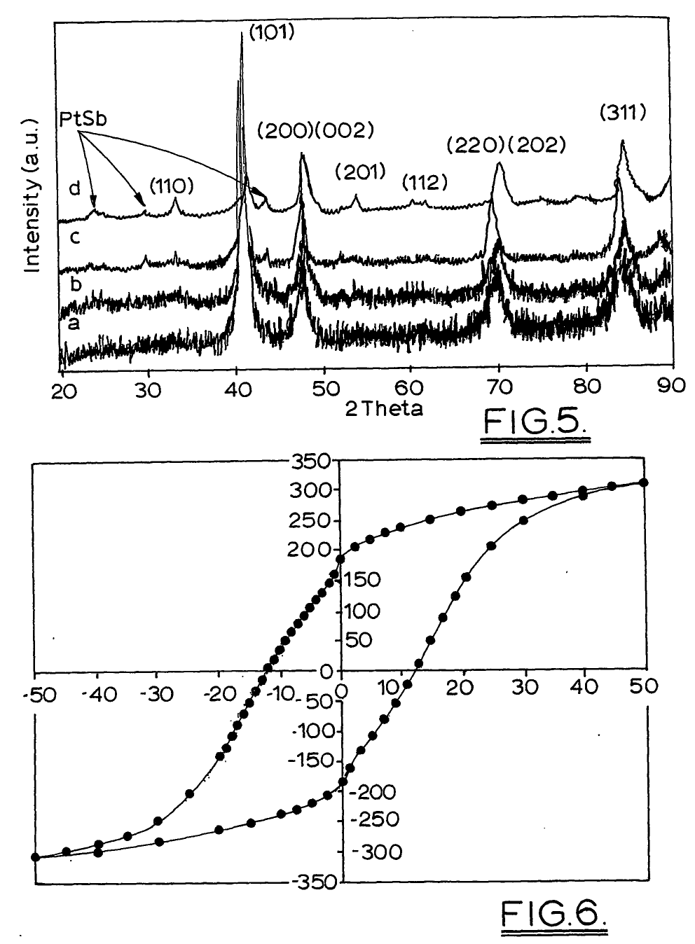

FIG. 7 shows the B-H loop characteristics of an antimony modified nanoparticle alloy annealed at 500° C.;

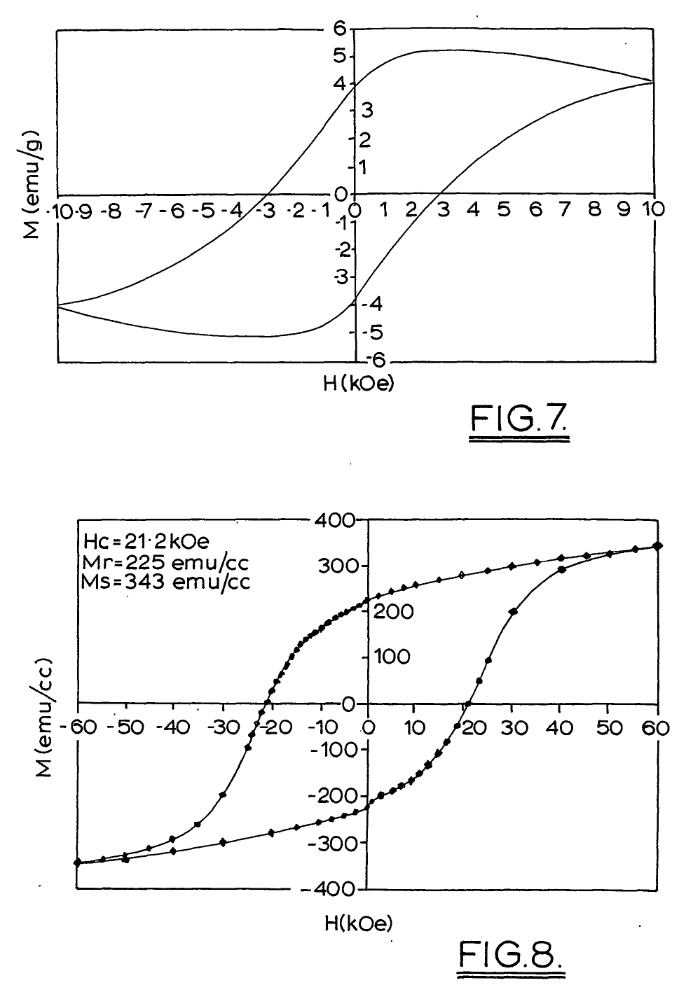

FIG. 8 shows the B-H loop characteristics of an antimony modified nanoparticle alloy annealed at 600° C. for 4 hours.

### EXAMPLE 1

Synthesis of CoPt Magnetic Alloy Nanoparticles:

Sodium tetrachloroplatinate tetrahydrate Na₂PtCl₄.4H₂O (99.99%), sodium borohydride NaBH₄ (98%), sodium bis(2-ethylhexyl) sulfosuccinate commonly known as AOT (99%) and cobalt chloride hexahydrate, n-heptane (99%) and ethanol (95%) were the ingradients used for the above mentioned synthesis.

The first step is to prepare reverse micellar solutions of cobalt and platinum ions of the desired concentration and water content w. A concentrated aqueous solution of cobalt chloride and sodium tetrachloroplatinate was solubilized in the solution of NaAOT in Heptane previously prepared, to the desired concentration of the ionic salts. The proportions of cobalt and platinum salts are based on the final alloy composition sought. For example, to prepare a micellar solution of Co:Pt with a 1:1 proportionality, the starting concentration of Co²⁺ and of Pt²⁺ should be 0.002M in a 100 mL flask with w=8. Cobalt chloride hexahydrate (47.6 mg) together with sodium tetrachloroplatinate (153 mg) in the form of powder were weighed into a flask. Doubly distilled water (3.6 mL) was then added to form very small but concentrated solution of Co²⁺ and Pt²⁺ ions in water. Then the previously prepared solution of NaAOT in heptane was added to this concentrated aqueous solution to fill to the mark.

Reverse micellar solution of sodium borohydride with the same water content, w=8 (3.6 mL) was prepared in a separate 100 mL volumetric flask in the same manner. This solution is then added into a vigorously mixing of reverse micellar solutions of the metal ions. The colour of the mixture turned from golden brown to black, indicating the formation of metallic nanoparticles. The stirring is maintained for 30 min to insure complete reduction of the metal ions.

After the reduction was complete, the alloy nanoparticles were extracted and washed with water-ethanol mixtures for effective removal of all the unwanted constituents such as the surfactant and the other byproducts of the reaction such as sodium chloride and the other borate species. The washed CoPt nanoparticles which are black in colour are then extracted by centrifugation. The as prepared CoPt nanoparticles are highly reactive and susceptible to oxidation and hence had to be dried under inert atmosphere (e.g. Ar). The drying temperature can be 60° C. for 5 hours.

This product is then subjected to various annealing treatments to improve its magnetic characteristics,

Physical and Magnetic Characteristics of the as Synthesized CoPt Nanoparticles:

The as synthesized product, dried at 60° C., is a very fine powder which exhibits broad diffraction peaks in the X-ray diffractrogram revealing that the low temperature synthesis did produce crystalline grains whose average size is about 4 nm as calculated from Scherrer's XRD line width expression. FIG. 1 a gives the XRD pattern for the CoPt alloy nanoparticles as prepared and dried at 60° C. The observed absorption peaks in the XRD pattern could be indexed to face centered cubic pattern with lattice constant 3.8567±0.0003 Å.

High Resolution Transmission electron Microscope (HRTEM) studies also confirmed that the as-synthesized CoPt alloy nanoparticles are well-formed nanocrystallites. Most of the particles sizes were in the range of 3-5 nm (see FIG. 2). The bright field HRTEM image of the as-synthesized CoPt alloy nanoparticles shown in FIG. 4 reveals the crystalline nature of the nanoparticles. These samples exhibit a superparamagnetic behavior (FIG. 3a) and remain so upto the annealing temperature 350° C. This is due to two factors namely small particle size and weak ferromagnetism. Firstly, particles exhibit superparamagnetism when the particle sizes are comparable to the magnetic domain wall width. Secondly, these samples particles possess a disordered cubic lattice structure which has low magnetic anisotropy constant resulting in weak ferromagnetic character (H_{c} values >20 Oe).

Annealing Treatment Induced Chances in the Physical and Magnetic Properties of CoPt Magnetic Nanoalloys:

The CoPt magnetic alloy nanoparticles were then annealed at different temperatures between 350° C. and 600° C. for pre-selected time duration. Upon heat treatment, noise level reduced considerably in the XRD pattern accompanied by the peak sharpening, which is indicative of the growth in particle size. The basic structure remained face centered cubic (fcc) during high annealing temperatures up to 550° C. with no appreciable change in the lattice constant (see FIG. 1b). Using Scherrer's formula, the particle size was calculated. The particle size increased from 3 nm at 60° C. to ˜6 nm at 550° C.

Table 1 shows the structural and magnetic characteristics of the CoPt magnetic alloy nanoparticles processed at different temperatures and different annealing durations.

TABLE 1

| | | | Particle | | |
|---|---|---|---|---|---|
| | Annealing | Annealing | size | | |
| S. No | Temperature ° C. | Time (hrs.) | (nm) | H_{c} (kOe) | Cₒ/aₒ |
| 1 | 350 | 1 | 3.304 | 0 | 1.00000 |
| 2 | 400 | 1 | — | 0.2 | 1.00000 |
| 3 | 450 | 1 | 3.582 | — | 1.00000 |
| 4 | 500 | 1 | 5.943 | 0.4 | 1.00000 |
| 5 | 550 | 1 | 5.390 | — | 1.00000 |
| 6 | 600 | 0.5 | 8.587 | 2.0 | 1.348814 |
| 7 | 600 | 2 | 9.216 | 3.5 | 1.362446 |
| 8 | 600 | 4 | 10.922 | 4.0 | 1.375861 |
| 9 | 600 | 6 | 14.424 | 4.6 | 1.379495 |
| 10 | 600 | 10 | 17.237 | 12.0 | 1.400158 |

Upon heating to 600° C. for 30 mins, an irreversible phase transformation occurred and new peaks were observed in the XRD pattern (FIG. 1c). All the peaks could be indexed to a face centered tetragonal (fct) lattice whose lattice constants a₀ and cₒ are 2.6767 Å and 3.7303 Å respectively. Maintaining the annealing temperature constant at 600° C. the annealing duration of varied from 30 min to a maximum of 10 hours. The cₒ/aₒ ratio (1.3488 for CoPt alloy obtained after half an hour heat treatment at 600° C.) gradually increased with duration of annealing. It reached 1.4001 for CoPt magnetic alloy nanoparticles annealed for 10 hours (FIG. 4). During this process, the average particle size also increased from ˜8 nm (for samples for half an hour) to about 17 nm (when heated to for 10 hours).

The magnetic coercivity (H_{c}) values increased considerably. The sample heat treated for half an hour showed H_{c} value of 2 kOe (see FIG. 3b) while the 10 hour heated sample exhibited 12 kOe (FIG. 3c). This is the highest value obtained for the free powder of CoPt magnetic alloy reported to date.

The XRD data (FIG. 1) also reveals that the product obtained has a high degree of phase purity as evidenced from the absence of diffraction peaks due to elemental platinum and elemental cobalt or any other impurities, even though their presence in trace amounts beyond the limit of XRD sensitivity cannot be ruled out. The proposed room temperature synthesis route yields CoPt alloy with disordered face centered cubic lattice, possibly be due to the high concentration of point defects in the as synthesized nanoparticles. The high temperature annealing treatment enables reduction of these defects resulting in the stabilization of the partially ordered face centered tetragonal phase, which is the room temperature stable phase resulting from the alloy melt that is reported in the literature.

### EXAMPLE 2

Synthesis of FePt Magnetic Alloy Nanoparticles

Sodium tetrachloroplatinate tetrahydrate Na₂PtCl₄.4H₂O (99.99%), sodium borohydride NaBH₄ (98%), sodium bis(2-ethylhexyl) sulfosuccinate commonly known as AOT (99%) and Iron chloride hexahydrate FeCl₂.6H₂O, n-heptane (99%) and ethanol (96%) were the ingredients used for the synthesis.

A reverse micellar solution containing Fe³⁺ and Pt²⁺ with overall concentrations, for each metal ion of 0.002 M in 100 ml and a water content of W=8 was prepared as follows:

Iron chloride hexahydrate (54.05 mg) together with Sodium tetrachloroplatinate in powder form were weighed into a 100 ml flask. Doubly distilled water (2.88 ml) was added to form a small concentrated solution of Fe³⁺ and Pt²⁺ ions in water. Then a previously prepared solution of AOT in heptane was added to the concentrated solution of Fe³⁺ and Pt²⁺ ions to fill to the mark. This suspension was homogenized by ultrasonication to form a clear golden brown solution. The Fe³⁺ and Pt²⁺ ions in solution were reduced into the metallic state with a reverse micellar solution of sodium borohydride. This reverse micellar solution of sodium borohydride was prepared in a separate 100 ml flask; doubly distilled water (2.88 ml) was added and filled to the mark. This solution was homogenized by ultrasonication. The reduction, extraction and purification of the alloy nanoparticles is similar to that in example 1. The average particle size is 3-5 nm.

### EXAMPLE 3

Synthesis of NiPt Magnetic Alloy Nanoparticles

Sodium tetrachloroplatinate tetrahydrate Na₂PtCl₄.4H₂O (99.99%), sodium borohydride NaBH₄ (98%), sodium bis(2-ethylhexyl) sulfosuccinate commonly known as AOT (99%) and Nickel chloride hexahydrate NiCl₂.6H₂O, n-heptane (99%) and ethanol (96%) were the ingredients used for the synthesis.

Nickel chloride hexahydrate (54.05 mg) together with Sodium tetrachloroplatinate in powder form were weighed into a 100 ml flask. Doubly distilled water (2.88 ml) was added to form a small concentrated solution of Ni²⁺ and Pt²⁺ ions in water. Then a previously prepared solution of AOT in heptane was added to the concentrated solution of Ni²⁺ and Pt²⁺ ions to fill to the mark. This suspension was homogenized by ultrasonication to form a clear golden brown solution. The Ni²⁺ and Pt²⁺ ions in solution were reduced into the metallic state with a reverse micellar solution of an equivalent amount of sodium borohydride. This reverse micellar solution of sodium borohydride was prepared in a separate 100 ml flask; Sodium borohydride (45.4 mg) powder was added to the flask; doubly distilled water (2.88 ml) was added and filled to the mark. This solution was homogenized by ultrasonication. The reduction, extraction and purification of the alloy nanoparticles is similar to that in example 1. The average particle size is 3-4 nm.

### EXAMPLE 4

Synthesis of CoPt Magnetic Alloy Nanoparticles with Chromium Substitution

Cr is commonly used as a substitute component in the transistion metal sitein parent compounds of CoPt, NiPt and FePt to obtain improved magnetic characteristics.

The amount of Cr used in CoPt, NiPt and FePt varies between 5 at % and 10 at % depending on the other components in the system. In this example Cr³⁺ concentration of 10 at % is used.

A reverse micellar solution containing Co²⁺, Pt²⁺ and Cr³⁺ with overall concentrations, Co²⁺, Pt²⁺ is 0.002 M in 100 ml and the concentration of Cr³⁺ is 0.0002M(10 at %) and a water content of W=8 was prepared as follows:

Cobalt chloride hexahydrate (47.6 mg) together with Sodium tetrachloroplatinate (76.6 mg) and chromium chloride hexahydrate (5.3 mg) in powder form were weighed into a 100 ml flask. Doubly distilled water (2.88 ml) was added to form a small concentrated solution of Co²⁺, Pt²⁺ and Cr³⁺ ions in water. Then a previously prepared solution of AOT in heptane was added to the concentrated solution of Co²⁺, Pt²⁺ and Cr³⁺ ions to fill to the mark. The Co²⁺, Pt²⁺ and Cr³⁺ ions in solution were reduced into the metallic state with a reverse micellar solution of an amount of sodium borohydride equivalent to one and a half times the stoichometric amount of ions in solution. This reverse micellar solution of sodium borohydride was prepared in a separate 100 ml flask; Sodium borohydride (48.8 mg) powder was added to the flask; doubly distilled water (2.88 ml) was added and filled to the mark. This solution was homogenized by ultrasonication. The reduction, extraction and purification of the alloy nanoparticles is similar to that in example 1.

### EXAMPLE 5

Synthesis of CoPt Magnetic Alloy Nanoparticles in the Presence of Antimony (Sb)

The concentration range of Sb is 5 to 15 at % based on equiatomic CoPt alloy. During this synthesis PTSb is also formed so that a compensating addition of Pt is made to minimize the formation of free Co which is susceptible to oxidation which deteriorates the hard magnetic properties of the nanoparticles.

A reverse micellar solution containing Co²⁺, Pt²⁺ and Sb³⁺ in an atomic percent of 39.5 at5 Co, %1.5 at % of Pt, ad 9 at % Sb with overall concentrations, Co²⁺, Pt²⁺ and Sb³⁺ of 0.01 M in 100 ml and a water content of W=8 was prepared as follows:

Cobalt chloride hexahydrate (94 mg) together with Sodium tetrachloroplatinate (197.2 mg) and antimony potassium tartrate (29.2 mg) in powder form were weighed into a 100 ml flask. Doubly distilled water (2.88 ml) was added to form a small concentrated solution of Co²⁺, Pt²⁺ and Sb³⁺ ions in water. Then a previously prepared solution of AOT in heptane was added to the concentrated solution of Co²⁺, Pt²⁺ and Sb³⁺ ions to fill to the mark. The Co²⁺, Pt²⁺ and Sb³⁺ ions in solution were reduced into the metallic state with a reverse micellar solution of an equivalent amount of sodium borohydride. This reverse micellar solution of sodium borohydride was prepared in a separate 100 ml flask; Sodium borohydride (48.8 mg) powder was added to the flask; doubly distilled water (2.88 ml) was added and filled to the mark. All solutions were homogenized by ultrasonication. The reduction, extraction and purification of the alloy nanoparticles is similar to that in example 1. The average particle size was 3-4 nm.

FIG. 5 illustrates XRD patterns for this alloy after annealing at 400° C. (curve a), 450° C. (curve b), 500° C. (curve c) and 550° C. (curve d).

As shown at curve a the annealing at 400° C. took place for 1 hour and a single phase of CoPt is formed indicating dissolution of the Sb in the Co Pt lattice. The lattice parameter cₒ/aₒ calculated for this phase is 1. The magnetic parameters are Mᵣ=74.8 emu/cc and H_{c}=7000e.

The sample treated at 450° C. for 1 hour (curve b) shows a single phase indicating that the CoPt with dissolved Sb is stable at this annealing temperature. The lattice parameter cₒ/aₒ calculated for this phase is 1. The magnetic parameters are Mᵣ=11.1 emu/cc and H_{c}=1.5 kOe.

The sample treated at 500° C. for 1 hour (curve c) shows SbPt separating out and simultaneously the CoPt exhibits fct structure. The lattice parameter cₒ/aₒ calculated for this phase is 0.996. The magnetic parameters are Mᵣ=67.2 emu/cc and H_{c}=2.7 kOe.

The sample treated at 550° C. for 1 hour (curve d) shows a stable phase separated SbPt and simultaneously the ordering of the CoPt lattice improves as indicated by the increase in intensity of the superstructure peaks which exhibit fct structure. The lattice parameter cₒ/aₒ calculated for this phase is 0.996. The magnetic parameters are Mᵣ=44.9 emu/cc and H_{c}=7 kOe.

FIG. 6 shows the B-H loop characteristics for the alloy of example 5 when annealed at 600° C. for 1 hour.

FIG. 7 shows the the B-H loop characteristics for the alloy of example 5 when annealed at 500° C. for 1 hour.

FIG. 8 shows the B-H loop characteristics for the alloy of example 5 when annealed at 600° C. for 4 hours.

The nanoparticles prepared according to this invention can be used in a range of applications.

Magnetic biobeads can be prepared by annealing at 300° C. for 1 hour to produce beads of particle size 2-4 nm with superparamagnetic characteristics.

Microactuator applications require alloy nanoparticles with lower magnetic hardness and annealing at 400-500° C. for 1-5 hours will produce suitable particles with a particle size of 6-8 nm.

High density magnetic storage media require nanoparticles of 8 nm exhibiting strong ferromagnetism (magnetic coercivity 5-8 kOe) and these can be produced by annealing at 500-600° C. for 1 hour.

Micromagnets for MEMS applications require nanoparticles of a size from 5-15 nm with strong.ferromagnetism (magnetic coercivity 10 kOe and above) and these can be produced by annealing at 600° C. for up to 10 hours.

From the above it can be seen that the present invention provides a cost effective process for producing a range of nanoparticle sizes. Those skilled in the art will realize that the invention may be varied without departing from the essential teaching of the invention.

1. A method of forming magnetic nanoparticles which includes the steps of
a) forming a concentrated aqueous solution of transition metal salts with platinum salts
b) dispersing the metal salt solution in a non aqueous solution of a surfactant
c) adding a reducing agent to reduce the metal salts to metallic alloy nano-particles in the absence of oxygen
d) separating the metallic alloy nanoparticles
e) heating the metallic alloy nanoparticles under controlled time, atmosphere and temperature conditions sufficient to form particles of a desired size and magnetic characteristics.

2. A method as claimed in claim 1 in which the transition metals are selected from salts of cobalt, nickel, iron and chromium.

3. A method as claimed in claim 2 in which Chromium is used as a substitution metal for part of the Nickel, Cobalt or Iron in the alloy.

4. A method as claimed in claim 2 in which a metal selected from Silver, Antimony Bismuth or Lead is added to the transition metal solution to lowering the fct phase formation temperature during the annealing process.

5. Nano particles of transition metals and platinum prepared by the process defined in claim 1 wherein the ratio of the transition metal to platinum in the alloy is x :1-x where x is from 0.4 to 0.6.

6. Nano particles of transition metals and platinum prepared by the process defined in claim 3 wherein the chromium content is between 5 and 10 at %.

7. Nano particles of transition metals and platinum prepared by the process defined in claim 4 wherein the additive metal content is between 5 and 15 at %.

8. Magnetic storage medium formed from equi-atomic nano particles of cobalt and platinum prepared by the process defined in claim 1 in which the alloy is annealed at a temperature of 500-600° C. and has a particle size of 8 to 12 nm.

9. Magnetic bio beads formed from nano particles prepared by the process defined in claim 1 in which the alloy is annealed at a temperature of 300° C. and has a particle size of 2 to 4 nm.

10. A micro actuator formed from magnetic nanoparticles produced by the process defined in claim 1 in which the particles have been annealed at 400 to 500° C. for 1 to 5 hours to form nanoparticles of 6 to 8 nm.

11. Annealed Nano particles of platinum and a transition metal selected from Nickel, Cobalt and Iron in which a metal selected from Silver, Antimony, Bismuth or Lead is added to the alloy to lower the fct phase formation temperature during the annealing process.

12. Micro magnets formed from nanoparticles produced by the process defined in claim 1 in which the particles have been annealed at 600° C. for up to 10 hours to form nanoparticles of 5 to 15 nm with magnetic coercivity from 10 kOe.
